(19) United States
(12) Patent Application Publication
(10) Pub. No.: US 2009/0149135 A1
(43) Pub. Date: Jun. 11, 2009

(54) DETECTION OF THE OPERATION OF A MICROWAVE OVEN BY SCANNING THE MEDIUM NOISE PATTERN

(75) Inventors: Stefan Mangold, Bern (CH); Zhun Zhong, Croton-On-Hudson, NY (US); Javier del Prado Pavon, Antibes (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,321

(22) PCT Filed: Nov. 14, 2005
(86) PCT No.: PCT/IB2005/053749

§ 371 Date: May 15, 2007

Related U.S. Application Data
(60) Provisional application No. 60/628,075, filed on Nov. 15, 2004.

(51) Int. Cl. H04B 1/38

(52) U.S. Cl. 455/77; 455/73

(57) ABSTRACT

A new type of measurement (150) recently adopted in the IEEE 802.11 wireless LAN standard is used by the a system and method that allows devices (301) to detect if microwave ovens (302) are operating in their vicinity. By scanning the medium, the devices (301) derive information about whether a commercial and/or residential microwave oven causes interference on the medium (310). The information is derived from the collected pattern of medium occupancy times that is characteristic of microwave ovens by using medium sensing histograms (150) defined by the standard.

The present invention relates to detection of microwave radiation in the 2.4 GHz unlicensed band using medium sensing in wireless local area networks (WLANs).

The industrial, scientific and medical (ISM) band at 2.4 GHz is reserved for many different types of apparatus, e.g., microwave ovens, medical diathermy and ultrasonic equipment, which radiate electromagnetic interference. This band can also be used for unlicensed communications provided certain regulatory requirements are met. Due to the attractiveness of unlicensed operation, many wireless networking devices have been developed and standardized to operate in this band, including IEEE 802.11b, HomeRF, Bluetooth, and some proprietary cordless telephones.

Many of these technologies are complementary and are likely to be deployed in the same environment. The IEEE 802.11b standard is the fastest and most popular WLAN technology as of today. As the price of using this technology becomes cheaper and cheaper, more and more IEEE 802.11b devices will be adopted and deployed in many different environments including offices, homes, and public places. Therefore, interference is not only likely to occur but its frequency of occurrence is likely to grow and become more important.

There is a considerable likelihood that devices designed to utilize the same frequency band as the ISM band will experience strong in-band interference from residential and commercial microwave ovens. This is especially true for Bluetooth and IEEE 802.11 protocols, which have been developed specifically to utilize a portion of the ISM spectrum. Therefore, reliable microwave radiation detection is needed by devices communicating via these protocols.

The system and method of the present invention reliably detects the operation of residential and commercial microwave ovens. Collecting information about the activity of other radio devices, such as residential and commercial microwave ovens, is going to become a necessary part of the functionality of any device operating in the ISM band. The characterization of interference from other radio devices requires a dedicated measurement set up. Collecting information about the activity of other radio devices is accomplished in the system and method of the present invention through medium sensing in IEEE 802.11 WLANs. The Task Group k (TGk) of IEEE 802.11 working group currently specifies several useful types of medium sensing measurement requests and reports, see, e.g., Draft Amendment to STANDARD FOR Information Technology—Telecommunications and Information exchange Between Systems—LAN/MAN Specific Requirements—Part 11:Wireless Medium Access Control (MAC) and physical layer (PHY) specifications, Amendment 7: Radio Resource Measurement, IEEE P802.11k/D1.0, July 2004 and Z. Zhong, S. Mangold and A. Soomro, Proposed Text for Medium Sensing Measurement Requests and Report, IEEE Working Document 802.11-03/340r1, May 2003, the entire contents of both of which are hereby incorporated by reference as if fully set forth herein. Using these medium sensing measurement requests and reports, information about ongoing activities of other radio devices is collected without receiving probe responses or beacons from other devices. For example, Received Power Indicator (RPI) is a quantized measure of the received power level as seen at an antenna connector and by using the information collected for RPI and clear channel assessment (CCA), RPI busy time histograms, RPI idle time histograms, and CCA time histograms are created from which it can be determined if there are non-802.11 devices, for example, microwave ovens, operating on the channel and what is their medium access pattern.

In a preferred embodiment, RPI histograms are created by a sensing device detecting and counting durations of times when the medium is busy and times when the medium is idle. The medium is identified as busy if the received power level is larger than a certain pre-determined RPI value. Otherwise, the medium is identified as idle. The busy and idle periods are used to build an interference pattern.

In an alternative embodiment, CCA busy and idle time histograms with preamble detection are created by interpreting the medium as busy only if there is an ongoing transmission from an 802.11 device. Such a transmission is identified by a recognizable preamble at the beginning of each transmission.

Thus, in the present invention, collecting information about the activity of other radio devices is done using medium sensing in IEEE 802.11 WLANs to create medium sensing time histogram reports. A sensing device builds one or more RPI busy histograms that represent an interference pattern based on busy and idle periods when the received power level is larger than a certain pre-determined value.

Fundamental to constructing these histograms is the characteristic of a microwave oven working with a single magnetron: it radiates microwaves depending on the oscillation of its magnetron, once every time t1. Typically, t1=16.67 ms in the United States of America and t1=20 ms in Europe, where 1 ms=1 millisecond, with a constant period. That is, residential microwave ovens having a single magnetron produce microwave radiation every other half-cycle of the frequency of the alternating current powering the oven. A microwave oven is referred to as trans-type microwave oven if the magnetron works with a conventional voltage transformer. Residential trans-type microwave ovens, i.e., microwave ovens that are used in domestic situations, typically operate with a single magnetron. The histograms developed using the current invention exhibit a half-cycle pulsed pattern in the presence of such microwave oven radiation.

Also fundamental to constructing these histograms is the characteristics of commercial microwave ovens are, for example, used in large kitchens of restaurants and typically operate with two magnetrons. Commercial microwave ovens radiate microwaves twice every time t1.

The interference from the commercial type of microwave oven has been more difficult to characterize than the interference from the residential microwave ovens, see, e.g., S. Kamerman and N. Erkoçevic, Microwave Oven Interference On Wireless Lans Operating in the 2.4 GHz Band, Revue HF, pp. 17-26, 2000. However, switching-type microwave ovens can be distinguished from trans-type microwave ovens because they operate with higher frequency switching circuits for the magnetron oscillation, see, e.g., J. Del Prado, and S. Choi, Empirical Study on Co-existence of IEEE 802.11b WLAN with Alien Devices in the 2.4 GHz Band, Philips Research USA—Tech Report TR-2001-044, December 2001. This results in repeated short microwave radiation periods of time t2 during the busy phase t1. Typically, t2=20 μs (1 μs=1 microsecond).

The system and method of the present invention can be used in all devices that sense the medium to build RPI busy time histograms and RPI idle time histograms.

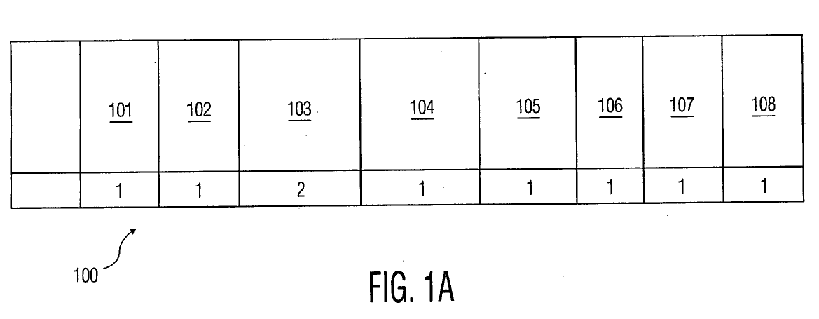

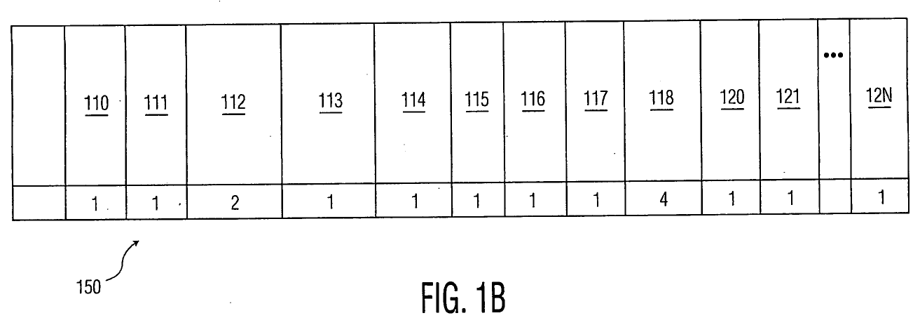

FIG. 1A illustrates an IEEE 802.11 k medium sensing time histogram request;

FIG. 1B illustrates an IEEE 802.11k medium sensing time histogram report;

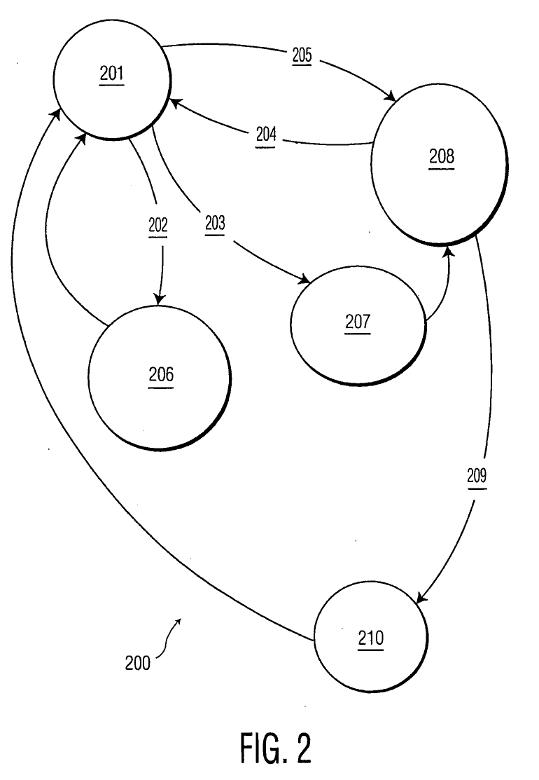

FIG. 2 illustrates a finite state diagram for the use of measurement requests and reports to detect microwave oven radiation according to a preferred embodiment of the present invention;

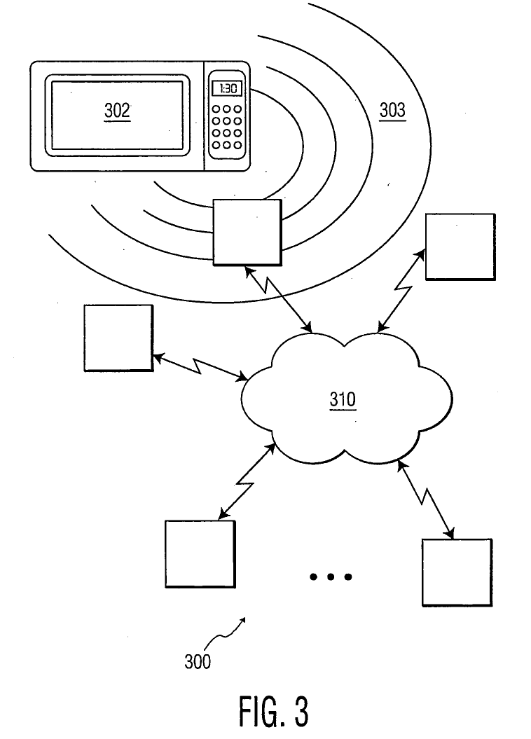

FIG. 3 illustrates a network of devices operating in the ISM frequency band and experiencing microwave oven radiation from a trans-type microwave oven;

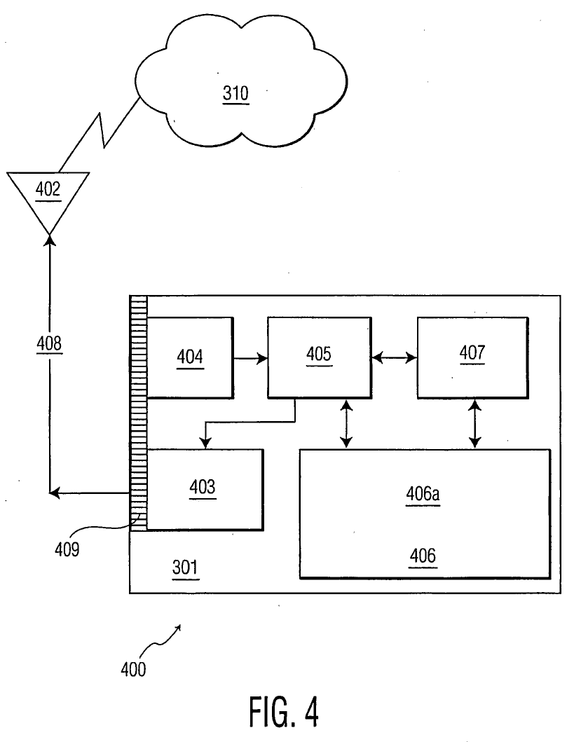

FIG. 4 illustrates a simplified block diagram of a wireless device modified according to the present invention to detect operation of microwave;

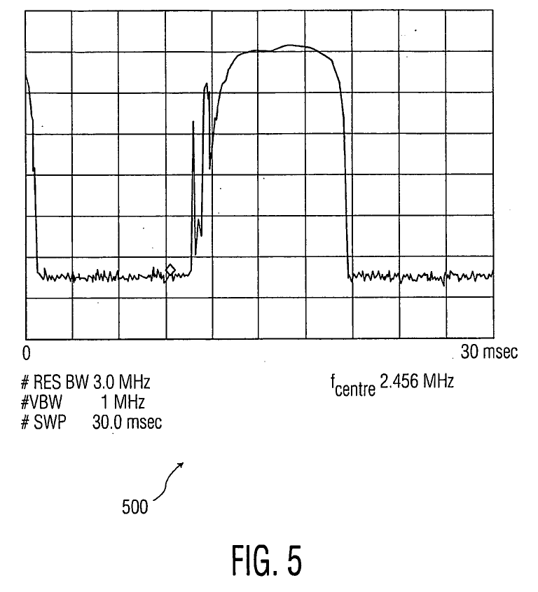

FIG. 5 illustrates a typical zero-span spectrum for a trans-type (home) microwave oven having a single magnetron; and

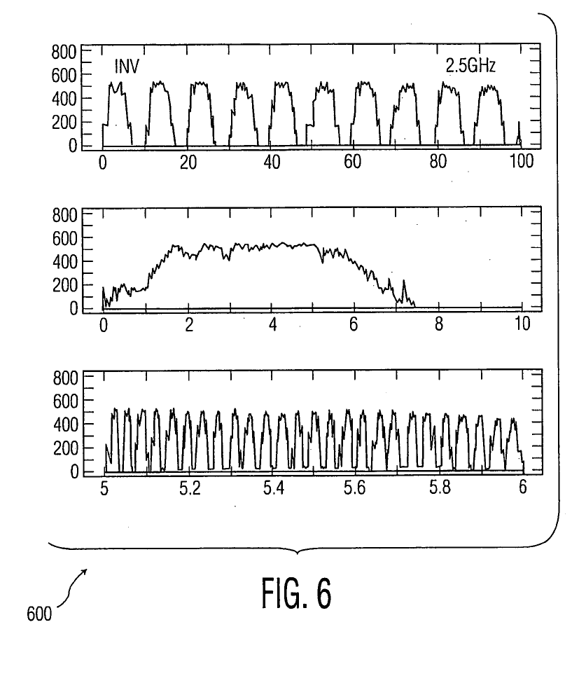

FIG. 6 illustrates a typical interference waveform for a commercial microwave oven.

In the following description, by way of explanation and not limitation, specific details are set forth such as the particular architecture, interfaces, techniques, etc., in order to provide a thorough understanding of the present invention. However, it will be apparent to those skilled in the art that the present invention may be practiced in other embodiments that depart from these specific details.

The present invention provides a system and method for an IEEE 802.11 device to detect microwave oven radiation using an RPI busy time histogram and an RPI idle time histogram. A first alternative embodiment also uses CCA busy and idle time histograms to improve the accuracy of such detection. A second alternative embodiment looks elsewhere in the spectrum for radiation from a microwave source to further support the accuracy of such detection. Finally, a third alternative embodiment employs time correlation of interference patterns for further support.

Microwave ovens create a characteristic interference pattern by radiating microwaves in regular periodic intervals, see, e.g., P. E. Gawthrop, F. H. Sanders, K. B. Nebbia and J. J. Sell, Radio Spectrum Measurements of Individual Microwave Ovens—Volume 1, NTIA Report 94-303-1, March 1994, the entire contents of which is hereby incorporated by reference as if fully set forth herein.

In a preferred embodiment, a device detects microwave ovens with a single magnetron and with two magnetrons using medium sensing measurement requests and reports to report usage patterns. The patterns are reported as time histograms, i.e., sets of values that represent the probability of occurrence (“densities”) of some busy and/or idle durations. Instead of providing histograms over different power levels, the time histograms provide information about busy and idle durations with a precision as defined in the request. For example, if a medium sensing time histogram with a slot precision is collected, information about the medium activities of other 802.11 devices can be derived from the collected information. The time histograms are simple to create without much effort, and clearly provide details about activities of other radio systems on a channel. This measurement allows improved radio resource measurement in 802.11 Wireless LAN.

As a main benefit of the Medium Sensing Time Histogram, information about ongoing activities of other radio devices can be collected without receiving probe responses or beacons from other devices during a measurement period. Once the information is collected, radio resource management is facilitated by addressing the following questions:
Are there other non-802.11 devices, for example, microwave ovens, operating on the channel and what is their medium access pattern (answer most likely to be provided through RPI and CCA time histogram) and
Is enough capacity left in the channel for sharing it with the 802.11 devices that are already operating on the channel (answer most likely to be provided through RPI and CCA idle time histogram).

The format of a Measurement Request field 100 corresponding to a Medium Sensing Time Histogram Request is shown in FIG. 1A.

The Channel Number 101 indicates the channel number for which the measurement request applies.

The Channel Band 102 indicates the frequency band, taken from Table 1, in which the Channel Number applies.

TABLE 1
Channel Band definitions for radio measurement requests

| Name | Channel Band |
|---|---|
| 2.4 GHz Band | 0 |
| 5 GHz Band | 1 |
| Reserved | 2-255 |

The Measurement Duration 103 is set equal to the duration of the requested measurement, expressed in Timer Units (TUs).

The Medium Sensing Measurement Subtype 104 indicates the subtype of Medium Sensing Measurements to make. The available subtypes of Medium Sensing Measurement are defined in Table 2.

TABLE 2
Medium Sensing Measurement Subtype definition

| Medium Sensing | |
|---|---|
| Measurement | Medium Sensing Measurement |
| Subtype | Name |
| 0 | RPI Time Histogram |
| 1 | CCA Idle Time Histogram |
| 2 | CCA Busy Time Histogram |
| 3 | NAV Busy Time Histogram |
| 4-255 | Reserved |

The Bin Offset 106 indicates the position of the first bin, expressed in microseconds.

The Bin Interval 107 indicates the time interval during which Medium Sensing Events are counted to be in this bin, expressed in slot times. Medium Sensing Events are defined in Table 3.

The Number of Bins 108 indicates the total number of time intervals that are covered by the time histogram.

The format of the Measurement Report field of a Medium Sensing Time Histogram Report is shown in FIG. 1B.

The Channel Number 110 indicates the channel number to which the Medium Sensing Time Histogram Report applies.

The Channel Band 111 indicates the measured frequency band, taken from Table 2, in which the Channel Number applies.

The Measurement Duration 112 is set equal to the duration over which the Media Sensing Time Histogram Report was measured, expressed in TUs.

The Medium Sensing Measurement Subtype 113 indicates the subtype of Medium Sensing Time Histogram Report, as defined in Table 2.

The RPI Threshold 114 identifies a received power level threshold according to Table 3, as seen at the antenna connector. The RPI Threshold 114 is used to determine if a Medium Sensing Event occurs, while collecting information for the RPI Time Histogram.

TABLE 3
RPI Threshold Definitions for an RPI Time Histogram

| RPI | Power Observed at Antenna (dBm) |
|---|---|
| 0 | −87 |
| 1 | −82 |
| 2 | −77 |
| 3 | −72 |
| 4 | −67 |
| 5 | −62 |
| 6 | −57 |
| 7-255 | Reserved |

The Medium Sensing Time Histogram Report 150 contains the densities in each of the N time intervals as measured in the specified channel over the measurement duration.

The Total Number of Medium Sensing Events 118 indicates how many events have been counted during the measurement. The Medium Sensing Events are defined in Table 4.

TABLE 4
Definition of Medium Sensing Event

| Medium | | |
|---|---|---|
| Sensing | Medium Sensing | |
| Measurement | Measurement | |
| Subtype | Name | Medium Sensing Event for Bin i |
| 0 | RPI Time | RPI changes from value higher than |
| | Histogram | threshold to value lower than RPI |
| | | threshold within the interval |
| | | (i0 + [i*Δi . . . (i + 1)*Δi]) |
| 1 | CCA Idle Time | CCA state changes from idle to busy |
| | Histogram | within the interval (i0 + |
| | | [i*Δi . . . (i + 1)*Δi]) |
| 2 | CCA Busy Time | CCA state changes from busy to idle |
| | Histogram | within the interval (i0 + |
| | | [i*Δi . . . (i + 1)*Δi]) |
| 3 | NAV Busy Time | NAV duration within the interval |
| | Histogram | (i0 + [i*Δi . . . (i + 1)*Δi]) detected |
| 4-255 | Reserved | reserved |

To compute the Bin i density, 0≦i<N, a device monitors the contiguous duration of the monitored state and increments count, Bᵢ, corresponding to Bin i. If a Medium Sensing Event occurs during the measurement at time t with

i₀+(i*Δi)<t≦i₀+(i*Δi) for any i<N−1,

i₀+(N*Δi)≦t for i=N−1 (1)

then the number of events per Bin i is increased by one. During the Medium Sensing Measurement, a histogram is generated that represents the probability distribution of Medium Sensing Events in time.

A device receiving one or more Medium Sensing Time Histogram Requests responds with a Medium Sensing Time Histogram Report containing the histogram(s) according to the requested Medium Sensing Measurement Subtype(s). To provide information that allows a requester to assess the confidence level of the reported data, the total number of counted Medium Sensing Events is also provided. By analyzing Medium Sensing Time Histograms, it can be estimated if other non-802.11 radio devices operate on the sensed channel and how their medium access is distributed over time. This information is used in the present invention to detect microwave oven operation in the vicinity of the device, for example, by comparing the histograms developed in the foregoing manner with pre-stored archetypical patterns. In one aspect of the invention, if the developed histograms exhibit a pre-determined pattern, e.g., are correlated over time within a predetermined tolerance, it can be assumed with a known confidence level that a microwave oven of a given type corresponding to the pre-stored pattern is operating within radio range of the measuring device.

Referring now to FIG. 2, a device operates normally and periodically, also scans the medium 201 and collects information about interference patterns until a sufficient number of measurements (bins as described above) have been collected 203 and from time-to-time receives measurement reports 205. The device also repeatedly 202 sends 206 medium sensing measurement requests 100. If RPI and CCA with and without preambles are sensed 207 as well as when medium sensing reports are received 205, the device stores the respective histograms and reports 208. In one aspect of the present invention, microwave oven interference is determined to exist by a pattern recognition module performing a comparison with pre-stored patterns, e.g., a device can determine that a trans-type microwave oven having a single magnetron is active in the medium and causes interference by comparing its stored histogram with a pattern such as that illustrated in FIG. 5.

Referring now to FIG. 3, a wireless network is illustrated of devices 301 modified according to the present invention and using mesh technology to communicate over the medium 310 in the ISM band. The devices are experiencing interference 303 from a microwave oven 302 and detecting the interference.

Referring now to FIG. 4, each device 301 comprises at least one radio front end 409 coupled to at least one antenna 402 to sense the medium and operatively coupled, respectively, to a receiver 404 and transmitter 403 to send and receive RPI and CCA measurement reports 150 and requests 100 and to sense the medium for transmission of other devices in the ISM band; a processor 405 to manage the collection and storage of measurements and transmission of reports; a memory 407 to store pre-determined patterns, measurement reports, bins for development of histograms and results of comparisons and pattern recognition activities; a pattern recognition module 406a for recognizing patterns over time of histograms and a histogram generator 406 to develop histograms from medium sensed inputs using equation (1) above.

Time histograms are collected by direct sensing of the medium and requesting and receiving measurement reports, and, preferably, if they show one or more of the following characteristics it is likely that a microwave oven is operating in the vicinity:
the probability of occurrence of busy times with a duration of t=0.5*t1 is high (for RPI busy time histogram, the density at the bin for the time t=0.5*t1 shows a value that exceeds a threshold, see Table 3.
the probability of occurrence of idle times with a duration of t1>t>0.5*t1 is low (for RPI idle time histogram, the density at all bins at t1>t>0.5*t1 show values below a threshold); and
the probability of occurrence of idle times with a duration t>t1 is zero (for RPI idle time histogram, the density at all bins for time t>t1 show a value of zero).
   Given this information, a microwave oven can be detected by identifying the interference pattern that is characteristic for the single magnetron microwave ovens. As described above, it has a periodic interval of 16.67/20 ms.

By scanning the medium and collecting information about interference patterns, a device can determine that a trans-type microwave oven having two magnetrons is active in the medium and causes interference. Preferably, time histograms are collected and if they show one or more of the following characteristics it is likely that a microwave oven is operating in the vicinity:
the probability of occurrence of busy times with a duration of t=0.25*t1 is high (for RPI busy time histogram, the density at the bin for the time t=0.25*t1 shows a value that exceeds a threshold, see Table 3).
the probability of occurrence of idle times with a duration of 0.5 t1>t>0.25*t1 is low (for RPI idle time histogram, the density at all bins at 0.5 t1>t>0.25*t1 show values below a threshold); and
the probability of occurrence of idle times with a duration t>0.5*t1 is zero (for RPI idle time histogram, the density at all bins for time t>0.5*t1 show a value of zero).
   Given this information, a microwave oven having two magnetrons can be detected by identifying the interference pattern that is characteristic for the two magnetrons microwave ovens. The interference pattern is the same as for the single magnetron microwave oven, but the radiation has double frequency so that the square wave occurs twice every t1.

Switching-type microwave ovens can be identified with the following method that may be used together with the previously described method, see FIG. 6. It can be concluded that a switching-type microwave oven is active in the medium and causes interference, if the collected time histograms show the following characteristics:
the probability of occurrence of busy times with a duration of t=0.5*t2 is high (for RPI busy time histogram, the density bin at the time t=0.5*t2 shows a value that exceeds a threshold, see Table 3).
the probability of occurrence of CCA busy times with a duration of t=0.5*t2 is low (for CCA busy time histogram, the density bin at the time at t=0.5*t2 show values below a threshold).

Given this information, a switching-type microwave oven can be detected by identifying the interference pattern that is characteristic for the switching type microwave ovens, see FIG. 6. The waveform exhibits the same characteristics as described for a trans-type oven. In addition, during the ON-TIME there is a second square-wave with a much shorter frequency of 20 usec. This is a result of the faster switching of the magnetrons in this type of microwave ovens, and creates a characteristic pattern.

In an alternative embodiment, CCA busy time histograms are collected with preamble detection. During periods when a microwave oven radiates power, the medium will be detected as idle through the CCA process. The value of the CCA busy time histogram at density bin for time 0.5*t1 will remain below a certain threshold and thus will indicate that the interference detected with the RPI busy time histogram is not created by interference from other IEEE 802.11 devices. This additional information can increase the probability of microwave detection.

In yet another alternative embodiment, parallel parts of the spectrum that are not used for IEEE 802.11 communications are scanned to detect characteristic secondary peaks of power that are radiated by microwave ovens. This additional information can increase the probability of microwave detection.

In yet another alternative embodiment, information is collected about the time correlation of interference patterns. This information is for example calculated a priori and stored in the wireless device. A pattern recognition module 406a can later compare the interference measured on the air with the previously stored data. This additional information can increase the probability of microwave detection.

Given the above information about the operation of microwave ovens in their vicinity, devices will be able to dynamically optimize their radio resource management, such as the selection of communication channels, transmission power, and the selection of modulation and coding schemes.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation, such as format changes of the request and response frames and elements thereof, and the teaching of the present invention can be adapted in ways that are equivalent without departing from its central scope. Therefore it is intended that the present invention not be limited to the particular embodiment disclosed as the best mode contemplated for carrying out the present invention, but that the present invention include all embodiments falling within the scope of the appended claims.

1. A wireless device (301) for detecting interference from a microwave oven (302), comprising:
a radio front end (409) including an antenna (402) tuned to a 2.4 GHz band;
a receiver (404) operably coupled to the radio front end antenna to receive medium sensing inputs from a transmission medium;
a transmitter (403) operably coupled to the antenna to transmit medium sensing outputs over the transmission medium;
at least one pre-determined pattern (500) (600) that is characteristic of the operation of at least one type of microwave oven selected from the group consisting of single magnetron trans-type, double magnetron trans-type, and switching-type; and
a processor (405) operably coupled to the receiver (404) and the transmitter (403) to respectively detect interference from a microwave oven (302) contained in the received medium sensing inputs (408) and to send outputs comprising said generated pattern (408), wherein, said processor (405) generates an interference pattern from said inputs and compares said generated pattern to said at least one pre-determined pattern to determine the likelihood of the presence of microwave oven interference on the medium (310).

2. The wireless device (301) of claim 1, wherein said processor (405) is further configured to repeatedly send a medium sensing request (100) to other devices within radio range of the wireless device (301) requesting the other devices (301) to report (150) on medium sensing performed by the other devices (301).

3. The wireless device (301) of claim 1, wherein said medium sensing inputs comprise:
medium sensing reports (150) sent by other devices within radio range the wireless device (301); and
direct sensing of the medium by the wireless device (408).

4. The wireless device (301) of claim 3, wherein said processor (405) is further configured to repeatedly send a medium sensing request (100) to other devices (301) within radio range of the wireless device (301) requesting the other devices (301) to perform and report on a particular type of medium sensing measurement performed by the other devices (301), said particular type being intended to detect interference from microwave ovens (302).

5. The wireless device (301) of claim 4, further comprising:
a memory (407) coupled to the processor (405);
said at least one pre-determined pattern (500) (600) being one of stored in said memory (407) or programmed in said processor (405); and
wherein, the processor (405) is further configured to:
i. generate and store in the memory at least one medium sensing report (150) from the received medium sensing inputs (408), and
ii. store in the memory (407) the received medium sensing reports (150).

6. The wireless device of claim 5, wherein:
said medium sensing requests (100) are requests for medium sensing time histograms for a specified type of activity on the medium; and
said medium sensing reports are medium sensing time histogram reports (150) for a specified type of activity on the medium (310).

7. The wireless device of claim 6, wherein:
the specified type of activity is Received Power Indicator and Clear Channel Assessment, respectively having a first and second pre-determined threshold, RPI having a first pre-determined threshold selected from the group consisting of the entries in the table

| RPI | Power Observed at Antenna (dBm) |
|---|---|
| 0 | −87 |
| 1 | −82 |
| 2 | −77 |
| 3 | −72 |
| 4 | −67 |
| 5 | −62 |
| 6 | −57 |
| 7-255 | Reserved |

and a medium sensing event for bin i (i=0, . . . , N−1), such that each activity type is counted using associated bin i at a time t if, respectively, RPI changes from a value higher than a RPI threshold to a value lower than RPI threshold and CCA changes from busy to idle within an interval
i₀+(i*Δi)<t≦i₀+(i*Δi) for any i<N−1,
i₀+(N*Δi)≦t for i=N−1
of the contiguous duration of the monitored event.

8. The wireless device (301) of claim 7, wherein the processor (405) is further configured to determine microwave oven interference on the medium (310) is interference from a single magnetron microwave oven if at least one of the conditions holds selected from the group consisting of
i. the probability of occurrence of busy times with a duration of t=0.5*t1 is greater than a pre-determined third threshold such that for RPI busy time histogram, the density at the bin for the time t=0.5*t1 has a value that exceeds the first threshold,
ii. the probability of occurrence of idle times with a duration of t1>t>0.5*t1 is less than a pre-determined fourth threshold such that for RPI idle time histogram, the density at each bin in the range t1>t>0.5*t1 has a value below the first threshold, and
iii. the probability of occurrence of idle times with a duration t>t1 is zero such that for RPI idle time histogram, the density at each bin for time t>t1 has a value of zero).
wherein, t1 equals at least one value selected from the group consisting of 16.67 ms and 20 ms.

9. The wireless device of claim 8, wherein the processor (405) is further configured to determine microwave oven interference on the medium is interference from a double magnetron microwave oven if at least one of the conditions holds selected from the group consisting of
i. the probability of occurrence of busy times with a duration of t=0.25*t1 is greater than a pre-determined fifth threshold such that for RPI busy time histogram, the density at the bin for the time t=0.25*t1 has a value that exceeds the first threshold,
ii. the probability of occurrence of idle times with a duration of 0.5*t1>t>0.25*t1 is less than a pre-determined sixth threshold such that for RPI idle time histogram, the density at each bin in the range 0.5*t1>t>0.25*t1 has a value below the first threshold, and
iii. the probability of occurrence of idle times with a duration t>0.5*t1 is zero such that for RPI idle time histogram, the density at each bin for time t>0.5*t1 has a value of zero).
wherein, t1 equals at least one value selected from the group consisting of 16.67 ms and 20 ms.

10. The wireless device of claim 9, wherein the processor (405) is further configured to determine microwave oven interference on the medium is interference from a switching-type microwave oven if each of the conditions hold:
i. the probability of occurrence of busy times with a duration of t=0.5*t2 is greater than a pre-determined seventh threshold such that for RPI busy time histogram, the density at the bin for the time t=0.5*t1 has a value that exceeds the first threshold, and
ii. the probability of occurrence of busy times with a duration of t=0.5*t2 is less than a pre-determined eighth threshold such that for CCA busy time histogram, the density at the bin for the time t=0.5*t2 has a value that is below the second threshold,
wherein, t2=20 μs.

11. The wireless device of claim 10, wherein the specified type of activity further comprises Clear Channel Assessment busy with preamble detection and if the CCA busy time histogram at bin for time 0.5*t1 remains below the pre-determined second threshold then the interference detected with an RPI busy time histogram is not from other IEEE 802.11 devices thereby increasing the probability of microwave detection.

12. The wireless device of claim 11, wherein at least one parallel part of the spectrum that excludes those parts used for, IEEE 802.11 communications is sensed to detect characteristic secondary peaks of power radiated by microwave ovens (302) whereby the probability of microwave detection is increased.

13. The wireless device of claim 11, wherein:
said device (301) further comprises a pattern recognition module (406a) operative coupled to said processor (405);
said at least one pre-determined interference pattern being one of stored in said memory (407) and programmed in said pattern recognition module (406a),
wherein, said pattern recognition module (406a) compares a busy time histogram with the at least one stored pre-determined interference pattern whereby the probability of microwave detection is increased.

14. A wireless communication system that minimizes the impact of microwave radiation on transmission, comprising:
a plurality of wireless communications devices (301) configured according to claim 1 to detect microwave interference in the 2.4 MHz band; and
wherein the processor (405) of each device (301) of said plurality is further configured such that when interference by at least one microwave oven is detected, said processor (405) optimizes radio resource management by choosing an alternative to at least one of the group consisting of communication channels, transmission power, modulation scheme and coding scheme.

15. A method for a wireless device (301) to detect interference from a microwave oven (302), comprising:
providing the device (301) with a radio front end (401) operatively coupled to at least one antenna (402);
tuning the radio front end (409) to a 2.4 GHz band;
sensing interference on the transmission medium (310) with the tuned radio front end (409);
generating an interference pattern using a histogram generator (406) from said sensed inputs as a generated medium sensing time histogram;
transmitting the generated histogram as a medium sensing time histogram reports (150) over the transmission medium (408);
providing at least one pre-determined pattern (500) (600) characteristic of the operation of at least one type of microwave oven selected from the group consisting of single magnetron trans-type, double magnetron trans-type, and switching-type; and
comparing (406a) said generated histogram to said at least one pre-determined pattern to determine the likelihood of the presence of microwave oven interference on the medium;
detecting interference from a microwave oven is present when said pre-determined pattern matches said generated histogram within a pre-determined tolerance.

16. The method of claim 15, further comprising the steps of:
receiving a microwave interference pattern (408) in a medium sensing time histogram report (150) over the medium sent by other devices within radio range;
performing the comparing and detecting steps with the received histogram (408) as the generated histogram; and
repeatedly sending a medium sensing request (100) to other devices within radio range of the wireless device (301) requesting the other devices (301) to report interference histograms based on medium sensing performed by the other devices (301).

17. The method of claim 16, wherein said medium sensing time histogram requests (100) and reports (150) correspond to a plurality of specified types of activity comprising a Received Power Indicator (RPI) and a Clear Channel Assessment (CCA), respectively having a first and second pre-determined threshold, RPI having a first pre-determined threshold selected from the group consisting of the entries in the table

| RPI | Power Observed at Antenna (dBm) |
|---|---|
| 0 | −87 |
| 1 | −82 |
| 2 | −77 |
| 3 | −72 |
| 4 | −67 |
| 5 | −62 |
| 6 | −57 |
| 7-255 | Reserved |

and a medium sensing event for bin i (i=0, . . . , N−1), such that each activity type is counted using associated bin i at a time t if, respectively, RPI changes from a value higher than a RPI threshold to a value lower than RPI threshold and CCA changes from busy to idle within an interval
i₀+(i*Δi)<t≦i₀+(i*Δi) for any i<N−1,
i₀+(N*Δi)≦t for i=N−1
of the contiguous duration of the monitored event.

18. The method of claim 17, further comprising the step of detecting interference from a single magnetron microwave oven if at least one of the conditions holds selected from the group consisting of
i. the probability of occurrence of busy times with a duration of t=0.5*t1 is greater than a third pre-determined threshold such that for RPI busy time histogram, the density at the bin for the time t=0.5*t1 has a value that exceeds the first threshold,
ii. the probability of occurrence of idle times with a duration of t1>t>0.5*t1 is less than a fourth pre-determined threshold such that for RPI idle time histogram, the density at each bin in the range t1>t>0.5*t1 has a value below the first threshold, and
iii. the probability of occurrence of idle times with a duration t>t1 is zero such that for RPI idle time histogram, the density at each bin for time t>t1 has a value of zero).
wherein, t1 equals at least one value selected from the group consisting of 16.67 ms and 20 ms.

19. The method of claim 18, further comprising the step of detecting interference from a double magnetron microwave oven if at least one of the conditions holds selected from the group consisting of
i. the probability of occurrence of busy times with a duration of t=0.25*t1 is fifth than a third pre-determined threshold such that for RPI busy time histogram, the density at the bin for the time t=0.25*t1 has a value that exceeds the first threshold,
ii. the probability of occurrence of idle times with a duration of 0.5*t1>t>0.25*t1 is less than a sixth pre-determined threshold such that for RPI idle time histogram, the density at each bin in the range 0.5*t1>t>0.25*t1 has a value below the first threshold, and
iii. the probability of occurrence of idle times with a duration t>0.5*t1 is zero such that for RPI idle time histogram, the density at each bin for time t>0.5*t1 has a value of zero).
wherein, t1 equals at least one value selected from the group consisting of 16.67 ms and 20 ms.

20. The method of claim 19, further comprising the step of detecting interference from a switching-type microwave oven if each of the conditions hold:
i. the probability of occurrence of busy times with a duration of t=0.5*t2 is greater than a seventh pre-determined threshold such that for RPI busy time histogram, the density at the bin for the time t=0.5*t1 has a value that exceeds the first threshold, and
ii. the probability of occurrence of busy times with a duration of t=0.5*t2 is less than a eighth pre-determined threshold such that for CCA busy time histogram, the density at the bin for the time t=0.5*t2 has a value that is below the second threshold,
wherein, t2=20 μs.

21. The method of claim 20, further comprising the steps of:
detecting preambles for Clear Channel Assessment busy histograms; and
determining if the CCA busy time histogram at the bin for time 0.5*t1 remains below the pre-determined second threshold such that the interference detected with the RPI busy time histogram is not from IEEE 802.11 devices and the probability of microwave detection by the RPI busy time histogram is increased.

22. The method of claim 21, further comprising the step of sensing a parallel part of the spectrum that excludes those parts used for IEEE 802.11 communications to detect characteristic secondary peaks of power radiated by microwave ovens whereby the probability of microwave detection is increased.

23. The method of claim 21, further comprising the steps of performing pattern recognition using a pattern recognition module (406) with the at least one pre-determined interference pattern and a busy time histogram whereby the probability of microwave detection is increased.
